(19) United States
(12) Patent Application Publication
(10) Pub. No.: US 2024/0384832 A1
(43) Pub. Date: Nov. 21, 2024

(54) HANDHELD FLOOR PAN TILT

(71) Applicant: Zhongshan Yangguo Electronic Technology CO.,Ltd, Zhongshan (CN)

(72) Inventor: WEIQIANG LUO, Zhongshan (CN)

(21) Appl. No.: 18/582,003

(22) Filed: Feb. 20, 2024

(30) Foreign Application Priority Data
May 16, 2023 (CN) 202321191065.X
May 16, 2023 (CN) 202321191076.8
May 16, 2023 (CN) 202321191139.X
Sep. 27, 2023 (CN) 202322654012.3

(51) Int. Cl. F16M 11/20; F16M 11/04; F16M 11/12

(52) U.S. Cl. CPC F16M 11/2092; F16M 11/041; F16M 11/126

(57) ABSTRACT

The present disclosure discloses a handheld floor pan tilt, a setting of a first connection mechanism, a first elastic member and a lateral axis body enables a second joint member to limit a lateral movement and laterally move to reset relative to a first joint member. When not moved laterally to reset, a position of the second joint member can be adjusted by rotating around the lateral axis body; a setting of a second connection mechanism, a second elastic member and a longitudinal axis body facilitates a third joint member to limit a longitudinal movement and move longitudinally to reset relative to the second joint member. When not moved longitudinally to reset, a position of the third joint member can be adjusted by rotating around the longitudinal axis body. Multiple foot supports are hinged on a side wall of a handle to facilitate an opening the foot supports.

### CROSS-REFERENCE TO RELATED APPLICATIONS

This application claims priority to Chinese Patent Application No. 202321191065.X, filed on May 16, 2023; 202321191139.X, filed on May 16, 2023; 202321191076.8, filed on May 16, 2023; and 202322654012.3, filed on Sep. 27, 2023 which are hereby incorporated by reference in its entirety.

### TECHNICAL FIELD

The present disclosure relates to a handheld floor pan tilt.

### BACKGROUND

At present, there are manually adjustable multi-joint mobile phone pan tilts/brackets, joints can rotate relative to each other, some joints are connected by a ball head, some joints are rotating connected by a way of bolt and nut, a damping structure is provided between the joints to render it difficult for the joints to rotate relative to each other after adjustment, or a movable locking tongue is provided to facilitate manual locking after adjustment, a main way to providing with the damping structure is through a friction between surfaces to form damping. In practice, when a mobile phone or camera on the pan tilt/bracket is heavy, the joints are prone to overcome the friction and unexpectedly rotate relative to each other. However, the method of providing with a movable lock tongue has the disadvantage of smaller size of the provided moving parts, rendering it inconvenient for a user to unlock and lock. Therefore, it is necessary to solve this problem.

In addition, there are handheld and floor pan tilts/brackets for mobile phone, but they lack a balance between both functions. It is necessary to solve this problem.

In addition, a clamping component on the existing pan tilt/brackets for mobile phone can only grip the phone in one direction, which is not convenient for more flexible use. It is necessary to solve this problem.

### SUMMARY

The present disclosure overcomes the shortcomings of the aforementioned technology and provides a handheld floor pan tilt.

To achieve the above objectives, the present disclosure adopts the following technical solutions.

A handheld floor pan tilt, including a first joint member 1, a second joint member 2, a third joint member 3, and a handle 15, where the handle 15 is connected with the first joint member 1 that can rotate and adjust front and rear positions and be fixed through a knob and a nut assembly 150; the first joint member 1 is connected with the second joint member 2 that can rotate and adjust a position around a lateral axis body 411 and limit a lateral movement through a first connection mechanism 4; the first connection mechanism 4 includes a first elastic member 40 for elastically driving the second joint member 2 to reset the lateral movement; a first multi gear lateral clamp positioning mechanism 5 is provided between the first joint member 1 and the second joint member 2 that prevents a relative rotation between the first joint member 1 and the second joint member 2 after a horizontal movement and resetting of the second joint member 2 is in place; the second joint member 2 is connected with the third joint member 3 that can rotate and adjust a position around a longitudinal axis body 611 and limit a longitudinal movement through a second connection mechanism 6, the second connection mechanism 6 includes a second elastic member 60 for elastically driving the third joint member 3 to longitudinally move and reset; a second multi gear longitudinal clamp positioning mechanism 7 is provided between the second joint member 2 and the third joint member 3 that prevents a relative rotation of the second joint member 2 and the third joint member 3 after a longitudinal movement and resetting of the third joint member 3 is in place; the third joint member 3 is connected with a rotatable rotating seat 8 driven by an electric motor, the rotating seat 8 is provided with a clamping component 9 for clamping and fixing an external equipment, a side wall surface of the handle 15 is hinged with several circumferentially distributed foot supports 16 hat can be opened and closed to support a selfie pan tilt to stand.

In an embodiment of the present disclosure, the first joint member 1 is provided with a first clamp port 10 for one end of the second joint member 2 to extend therein; the first connection mechanism 4 includes a first bolt 41 that horizontally passes through the first joint member 1 and the second joint member 2 at the first clamp port 10; the lateral axis body 411 is a part of the first bolt 41, and the other end of the first bolt 41 is connected with a first nut 42; the first elastic member 40 is a spring sleeved on the first bolt 41 for elastically driving the second joint member 2 to move horizontally and reset, and/or the second connection mechanism 6 includes a second bolt 61, configured to be thread connection with the second joint member 2 or thread connection with a fix nut in the second joint member 2 after longitudinally passing through the third joint member 3; where the longitudinal axis body 611 is a part of the second bolt 61, the second elastic member 60 is a spring sleeved on the second bolt 61 for elastically driving the third joint member 3 to longitudinal move and reset.

In an embodiment of the present disclosure, the first multi gear lateral clamp positioning mechanism 5 includes several first positioning grooves 51 that are distributed in a circular/arc shape on one side of the second joint member 2 and a first positioning protrusion 52 arranged on the first joint member 1 for laterally clamping with the first positioning groove 51; and/or the second multi gear longitudinal clamp positioning mechanism 7 includes several second positioning grooves 71 that are distributed in a circular/arc shape on the second joint member 2, and a second positioning protrusion 72 that is longitudinally clamped with the second positioning groove 71 on the third joint member 3.

In an embodiment of the present disclosure, one side of the first joint member 1 is provided with a first clamp hole 11, the first clamp hole 11 is detachably clamped and fixed with a first clamp block 12; one end of the first clamp block 12 penetrating into the first clamp hole 11 is provided with the first positioning protrusion 52, the first clamp block 12 is provided with a lateral channel for the lateral axis body 411 to cross, and/or one side of the second joint member 2 is provided with a second clamp hole 21, the second clamp hole 21 is detachably clamped with a second clamp block 22, the first positioning groove 51 is provided on the second clamp block 22, the second clamp block 22 is provided with a lateral channel for the lateral axis body 411 to cross.

In an embodiment of the present disclosure, the second joint member 2 is provided with a circular groove 23 for one end of the third joint member 3 to extend therein; the third joint member 3 is provided with a circular segment 31 for extending into the circular groove 23, the circular groove 23 is provided with a screw hole 231, the second bolt 61 longitudinally passes through the circular segment 31 and is thread connection to the screw hole 231.

In an embodiment of the present disclosure, the clamping component 9 includes a movable seat 92 connected to a left side of the rotating seat 8 through a first self-resetting guide mechanism 91 and a movable seat 92 connected to a right side of the rotating seat 8, each movable seat 92 can move away/close to the rotating seat 8 along the left and right axis and reset in a direction close to the rotating seat 8 under a driving force of the first self-resetting guide mechanism 91; each movable seat 92 is provided with a first clamping body 931 and a second clamping body 932 distributed front and rear, a first clamping space 94 is formed between the clamping body of the movable seat 92 on the left side and the clamping body of the movable seat 92 on the right side for gripping a mobile phone; the first clamping body 931 is fixed on the movable seat 92, the second clamping body 932 is hinged on the movable seat 92 to swing around the left and right axis and move away/close to the first clamping body 931; a second self-resetting mechanism 95 is provided between the second clamping body 932 and the movable seat 92 for driving the second clamping body 932 to swing and reset in a direction of the first clamping body 931; a second clamping space 96 is formed between the first clamping body 931 and the second clamping body 932 for gripping the mobile phone.

In an embodiment of the present disclosure, the first self-resetting guide mechanism 91 includes several guide grooves 911 extending left and right on the rotating seat 8, where the guide grooves 911 are provided with a guide rod 912 fixedly connected to the movable seat 92 on a corresponding side; a portion of the guide rod 912 located within the guide groove 911 is sleeved with a reset spring 913; and/or the second self-resetting mechanism 95 includes a torsion spring 951 sleeved on a rotating shaft of the second clamping body 932, one end of the torsion spring 951 is fixed on the second clamping body 932 and the other end thereof abuts against the movable seat 92 on a corresponding side.

In an embodiment of the present disclosure, the handle 15 is provided with a telescopic rod 151, a top of the telescopic rod 151 that extends out is connected to the first joint member 1 through the knob and the nut assembly 150.

In an embodiment of the present disclosure, a camera 17 is provided on a side wall surface of the rotating seat 8 for capturing and tracking an object.

In an embodiment of the present disclosure, a detachable magnetic fill light 18 is further provided on the first joint member 1.

In an embodiment of the present disclosure, an adjustment component 19 is provided on the third joint member 3 for fixing/unlocking the rotating seat 8.

In an embodiment of the present disclosure, the adjustment component 19 includes several pin grooves 191 circumferentially distributed along a rotation axis on the rotating seat 8; an adjustment pin 192 is provided on the third joint member 3; the adjustment pin 192 can approach/move away from the rotation axis of the rotating seat 8 to insert/exit and rotate to the pin groove 191 at a corresponding position.

In an embodiment of the present disclosure, a bottom of the handle 15 is further provided with an expansion interface 152 for an external expansion device to connect and fix on a mobile phone pan tilt, and the expansion interface 152 is a nut or a regular polygon countersunk hole.

Compared with prior art, the beneficial effects of the present disclosure are:
1. A handheld landing pan tilt structure in the present disclosure is simple and easy to implement. A setting of a first connection mechanism on a first joint member, a first elastic member and a lateral axis body facilitates a second joint member to limit a lateral movement and laterally move to reset relative to the first joint member. When not moved laterally to reset, a position of the second joint member can be adjusted by rotating around the lateral axis body, a third joint member is connected to the second joint member, a position of the third joint member relative to the first joint member is adjusted by rotating around the lateral axis body. When the lateral movement is reset in place, a first multi gear horizontal clamp positioning mechanism is horizontally clamped and locked, so that the first joint member cannot rotate freely with the second joint member, which has good practicality; a setting of a second connection mechanism on the second joint member, a second elastic member and a longitudinal axis body facilitates the third joint member to limit a longitudinal movement and move longitudinally to reset relative to the second joint member. When not moved longitudinally to reset, the position of the third joint member can be adjusted by rotating around the longitudinal axis body. When the longitudinal movement is reset in place, the second multi gear longitudinal clamp positioning mechanism is longitudinally clamped and locked. Thus, the second joint member and the third joint member cannot rotate freely, has good practicality. In addition, several foot supports are hinged on one side wall of a handle, which facilitates an opening the foot supports for support when a floor function is needed, and a closing of the foot supports when a handheld function is needed, which has good practicality.
2. A first clamping space and a second clamping space are formed between clamp bodies of clamp components in the present disclosure, which facilitates selecting a corresponding clamping space according to a need and clamping a mobile phone, has good practicality.

### BRIEF DESCRIPTION OF DRAWINGS

FIG. 1 is a first structural diagram of the present disclosure.

FIG. 2 is a second structural diagram of the present disclosure.

FIG. 3 is a third structural diagram of the present disclosure.

FIG. 4 is a fourth structural diagram of the present disclosure.

FIG. 5 is a fifth structural diagram of the present disclosure.

FIG. 6 is a sixth structural diagram of the present disclosure.

FIG. 7 is a seventh structural diagram of the present disclosure.

FIG. 8 is an eighth structural diagram of the present disclosure.

FIG. 9 is a ninth structural diagram of the present disclosure.

FIG. 10 is a tenth structural diagram of the present disclosure.

FIG. 11 is an eleventh structural diagram of the present disclosure.

FIG. 12 is a twelfth structural diagram of the present disclosure.

FIG. 13 is a thirteenth structural diagram of the present disclosure.

FIG. 14 is a fourth structural diagram of the present disclosure.

FIG. 15 is a fifteen structural diagram of the present disclosure.

FIG. 16 is a sixteenth structural diagram of the present disclosure.

FIG. 17 is a seventeen structural diagram of the present disclosure.

FIG. 18 is an eighteenth structural diagram of the present disclosure.

### DESCRIPTION OF EMBODIMENTS

The following provides a further detailed explanation of the features of the present disclosure and other related features through embodiments, in order to facilitate the understanding of technical personnel in the same industry.

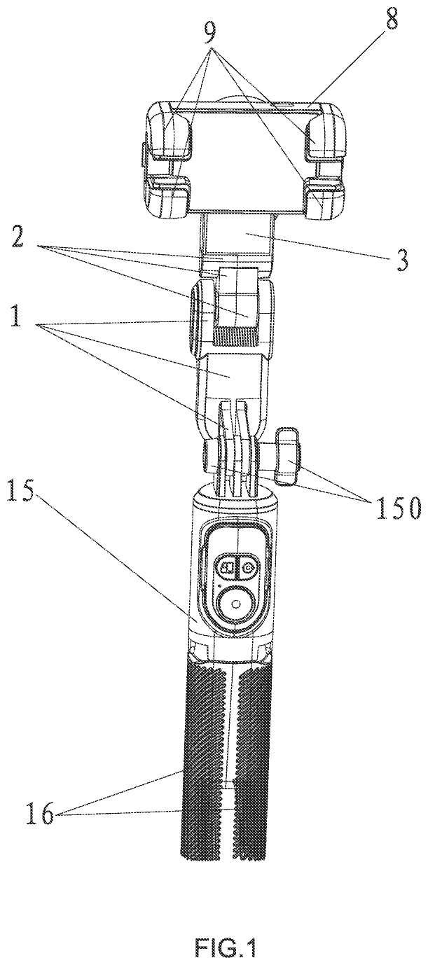

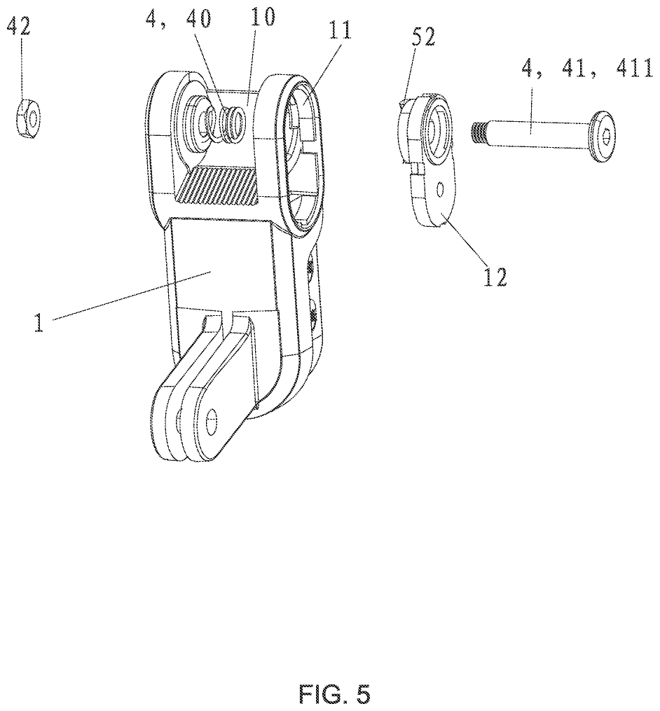

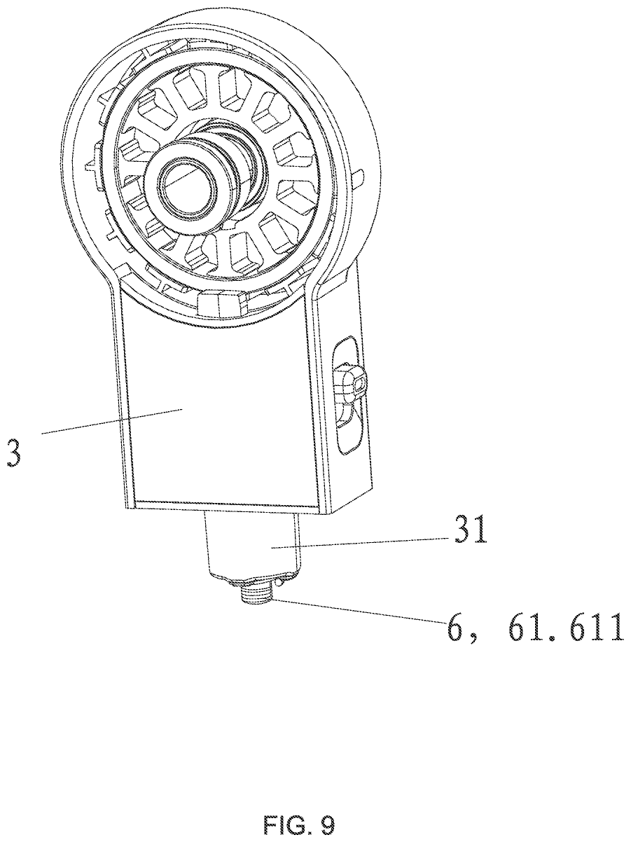

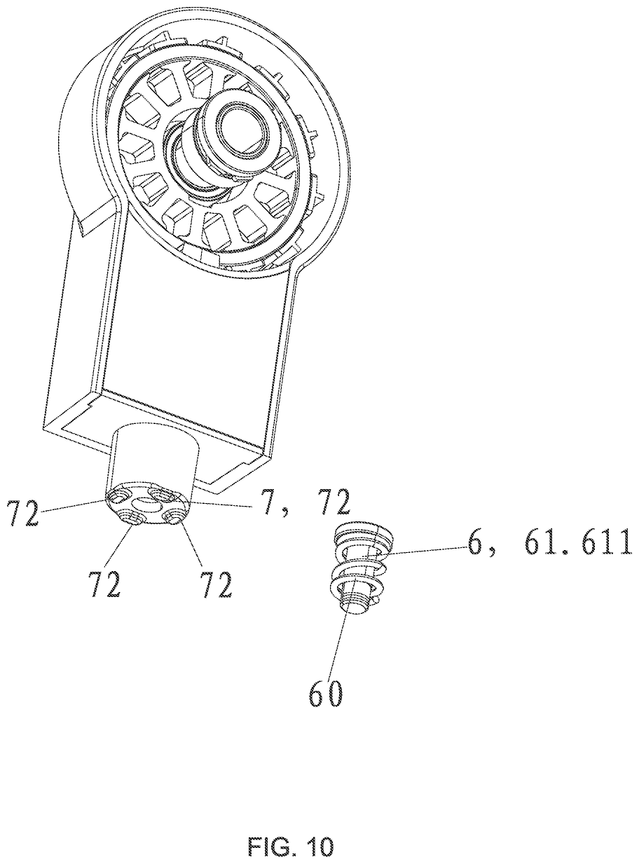

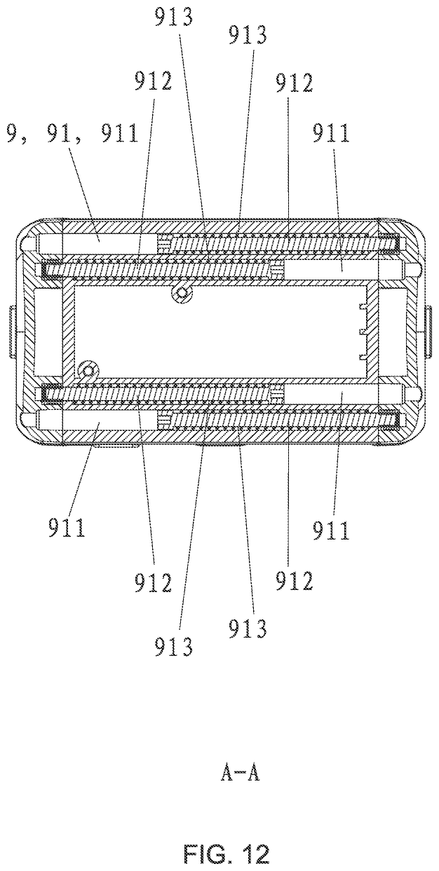

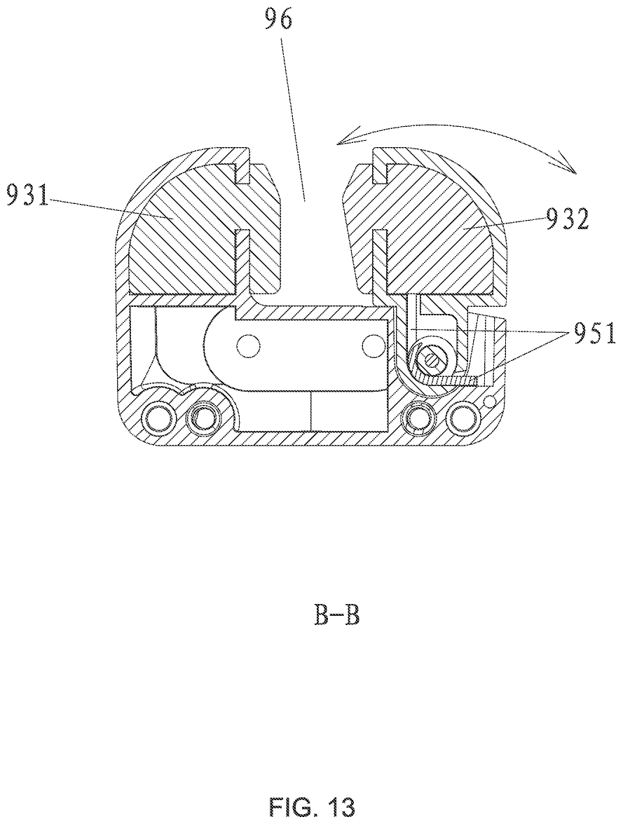

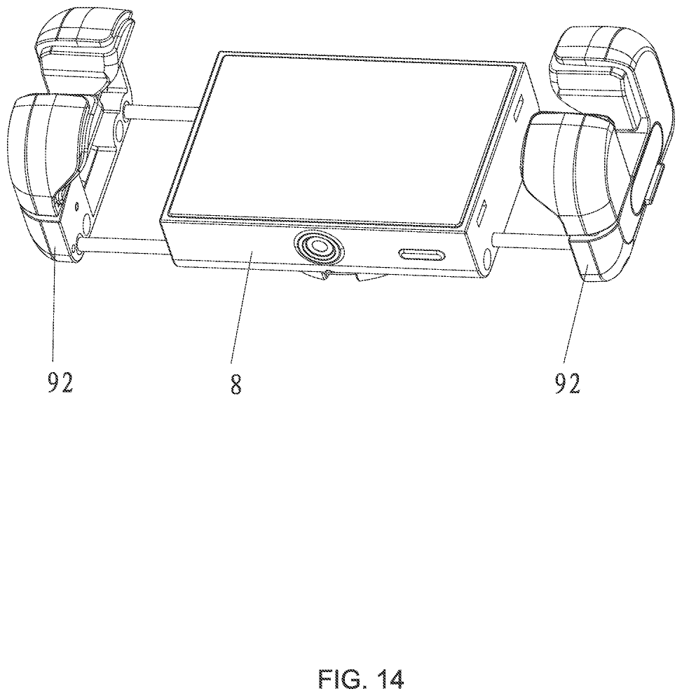

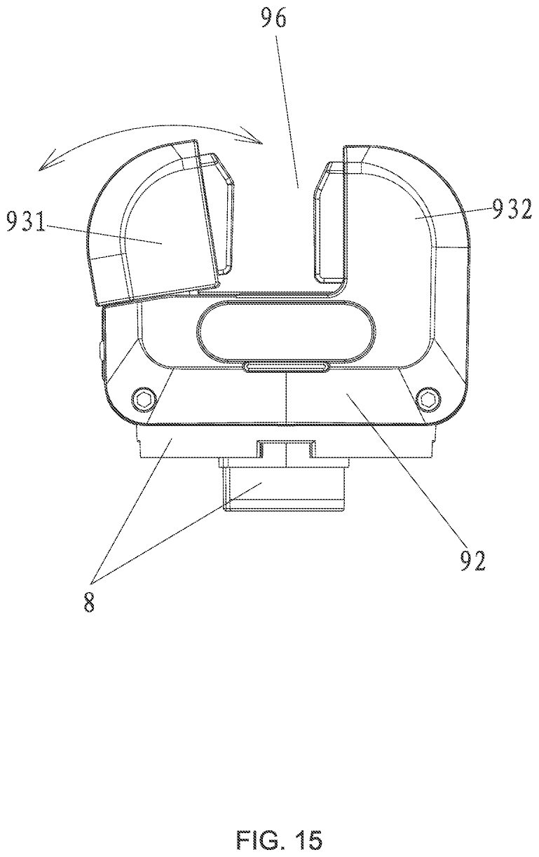

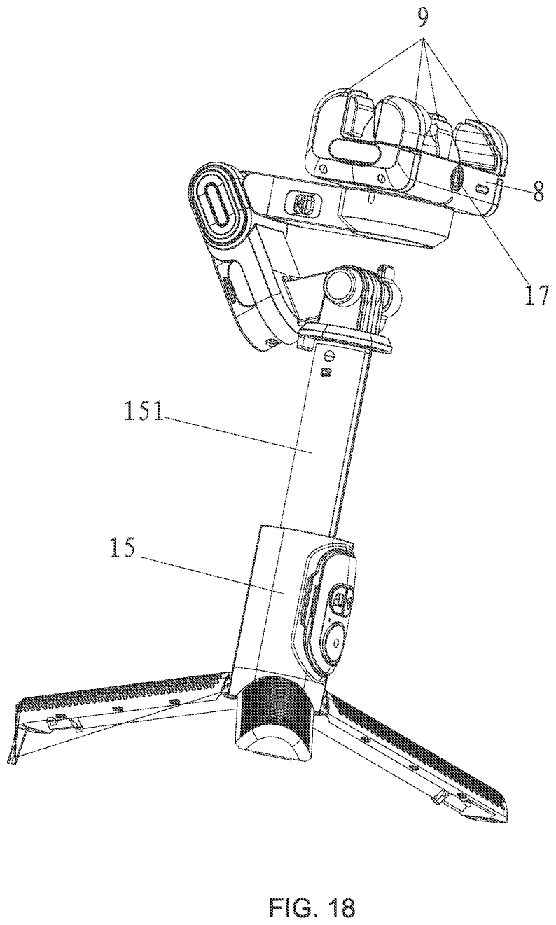

As shown in FIGS. 1 to 18, a handheld floor pan tilt includes a first joint member 1, a second joint member 2, a third joint member 3, and a handle 15. The handle 15 is connected with the first joint member 1 that can rotate and adjust front and rear positions and be fixed by a knob and a nut assembly 150. The first joint member 1 is connected with the second joint member 2 that can rotate and adjust a position around a lateral axis body 411 and limit a lateral movement through a first connection mechanism 4, the first connection mechanism 4 includes a first elastic member 40 for elastically driving the second joint member 2 to move horizontally and reset, a first multi gear lateral clamp positioning mechanism 5 is provided between the first joint member 1 and the second joint member 2 to prevent the first joint member 1 and the second joint member 2 to rotate relative to each other after the second joint member 2 moves horizontally and resets in place. The second joint member 2 is connected with the third joint member 3 that can rotate and adjust a position around a longitudinal axis body 611 and limit the longitudinal movement through the second connection mechanism 6. The second connection mechanism 6 includes a second elastic member 60 for elastically driving the third joint member 3 to move longitudinally and reset. A second multi gear longitudinal clamp positioning mechanism 7 is provided between the second joint member 2 and the third joint member 3, which is used for preventing the second joint member 2 and the third joint member 3 to rotate relative to each other after the third joint member 3 are longitudinally moved and reset in place. The third joint member 3 is connected with a rotating seat 8 driven by a motor, and a clamping component 9 is provided on the rotating seat 8 for clamping and fixing an external equipment. One side wall of a handle 15 is hinged with several circumferentially distributed foot supports 16 that can be opened and closed to support a selfie pan tilt to stand.

As mentioned above, the working principle between the joint member in the present disclosure is as follows: under an action of the first elastic member 40, the second joint member 2 moves laterally and resets in place, the first multi gear lateral clamp positioning mechanism 5 is horizontally clamped and locked to prevent a relative rotation between the first joint member 1 and the second joint member 2. When it is necessary to rotate and adjust the position of the second joint member 2, a user needs to first overcome a force of the first elastic member 40 and move the second joint member 2 laterally in an opposite direction to facilitate a lateral release and unlocking of the first multi gear lateral clamp positioning mechanism 5. Then, after rotating and adjusting the position of the second joint member 2, the user can release it. Under the action of the first elastic member 40, the second joint member 2 is horizontally moved and reset again to facilitate the first multi gear horizontal clamp positioning mechanism 5 to be horizontally clamped and locked again. Under the action of the second elastic member 60, the third joint member 3 moves longitudinally and resets in place. The second multi gear longitudinal clamp positioning mechanism 7 is longitudinally clamped and locked to prevent a relative rotation between the second joint member 2 and the third joint member 3. When it is necessary to rotate and adjust the position of the third joint member 3, the user needs to first overcome the force of the second elastic member 60 and move the third joint member 3 longitudinally in the opposite direction to facilitate a longitudinal disengagement and unlocking of the second multi gear longitudinal clamp positioning mechanism 7. Then, after rotating and adjusting the position of the third joint member 3, the third joint member 3 is released. Under the action of the second elastic member 60, the third joint member 3 is moved longitudinally again to reset so as to reengage and lock the second multi gear longitudinal clamp positioning mechanism 7 longitudinally.

As mentioned above, the handheld floor pan tilt structure in the present disclosure is simple and easy to implement. a setting of the first connection mechanism 4 on the first joint member 3, the first elastic member 40, and the lateral axis body 411 facilitates the second joint member 2 to limit a lateral movement and move laterally to reset relative to the first joint member 1. When not moved laterally to reset, the position of the second joint member 2 can be adjusted by rotating around the lateral axis body 411, and the third joint member 3 is connected to the second joint member 2, thereby also rotating around the lateral axis body 411 to adjust the position of the third joint member 3 relative to the first joint member 1. When the lateral movement is reset in place, the first multi gear lateral clamp positioning mechanism 5 is horizontally clamped and locked, so that the first joint member 1 and the second joint member 2 cannot rotate freely, which has good practicality. A setting of the second connection mechanism 6 on the second joint member 2, second elastic member 60, and longitudinal axis body 611 facilitates the third joint member 3 to limit a longitudinal movement and move longitudinally to reset relative to the second joint member 2. When not moved longitudinally to reset, the position of the third joint member 3 can be adjusted by rotating around the longitudinal axis body 611. When the longitudinal movement is reset in place, the second multi gear longitudinal clamp positioning mechanism 7 is longitudinally clamped and locked. Thus, the second joint member 2 and the third joint member 3 cannot rotate freely, has a good practicality. In addition, several foot supports 16 hinged on a side wall of the handle 15 facilitates an opening the foot support 16 for support when a floor function is needed, and a closing of the foot support 16 when a handheld function is needed, which has good practicality.

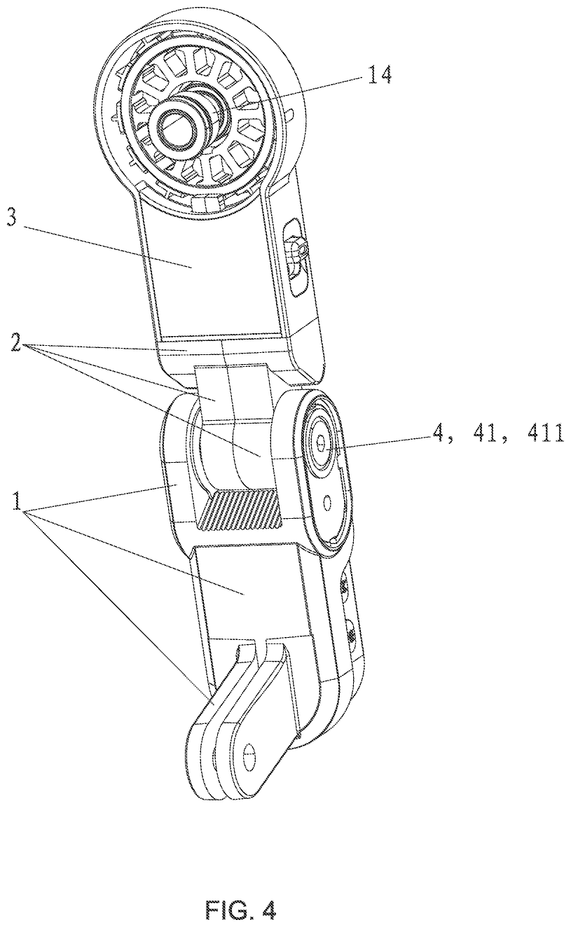

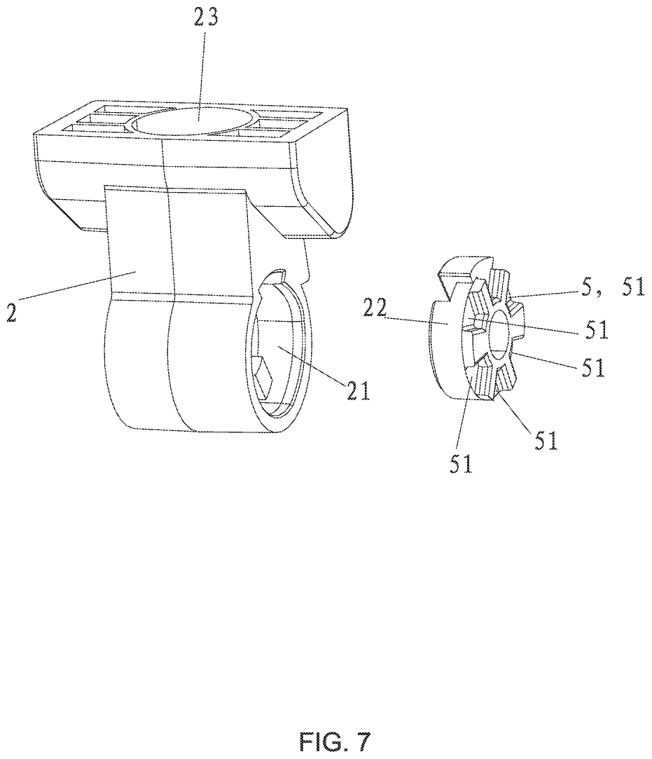

As shown in FIGS. 4 to 6, the first joint member 1 is provided with a first clamp port 10 for one end of the second joint member 2 to extend thereto. The first connection mechanism 4 includes a first bolt 41 for laterally passing through the first joint member 1 and the second joint member 2 at the first clamp port 10. The lateral axis body 411 is a part of the first bolt 41, and the other end of the first bolt 41 is connected to a first nut 42. The first elastic member 40 is a spring sleeved on the first bolt 41 for elastically driving the second joint member 2 to move horizontally and reset, as shown in FIGS. 7 to 10, and/or the second connection mechanism 6 includes a second bolt 61 for longitudinally passing through the third joint member 3 and then being thread connection with the second joint member 2 or thread connection with a fix nut of the second joint member 2. The longitudinal axis body 611 is a part of the second bolt 61, the second elastic member 60 is a spring sleeved on the second bolt 61 for elastically driving the longitudinal movement and resetting of the third joint member 3.

As mentioned above, the first clamp port 10 of the first joint member 1 in the present disclosure is arranged to facilitate one end of the second joint member 2 to extend into it and an arm body is formed on both sides of the first clamp port 10 for the first bolt 41 to pass through. Then, the first joint member 1 and the second joint member 2 are conveniently rotationally connected together through the first bolt 41 and the first nut 42. The implementation is convenient, and the first elastic member 40 is a spring, which is easy to sleeve on the first bolt 41 to elastically drive the second joint member 2 to move horizontally and reset, and its implementation is convenient. The second elastic member 60 and the second bolt 61 of the second connection mechanism 6 are provided for a convenient implementation.

As shown in FIGS. 4 to 6, the first multi gear lateral clamp positioning mechanism 5 includes several first positioning grooves 51 that are distributed in a circular/circular arc shape and arranged on one side of the second joint member 2, a first positioning protrusion 52 arranged on the first joint member 1 for laterally clamping with the first positioning groove 51, which facilitates a specific implementation, as shown in FIGS. 7 to 10, and/or the second multi gear longitudinal clamp positioning mechanism 7 includes several second positioning grooves 71 that are distributed in a circular/arc shape on the second joint member 2, a second positioning protrusion 72 arranged on the third joint member 3 is configured to be longitudinally clamp with the second positioning groove 71, and thereby facilitating a specific implementation.

As shown in FIGS. 4 to 6, one side of the first joint member 1 is concavely provided with a first clamp hole 11. The first clamp hole 11 is detachably clamped and fixed with a first clamp block 12. One end of the first clamp block 12 that penetrates into the first clamp hole 11 is provided with a first positioning protrusion 52. The first clamp block 12 is provided with a lateral channel for the lateral axis body 411 to cross, as shown in FIGS. 7 to 10, and/or one side of the second joint member 2 is concavely provided with a second clamp hole 21, the second clamp hole 21 is detachable and fixed with a second clamp block 22, and the first positioning groove 51 is provided on the second clamp block 22. The second clamp block 22 is provided with a lateral channel for the lateral axis body 411 to cross.

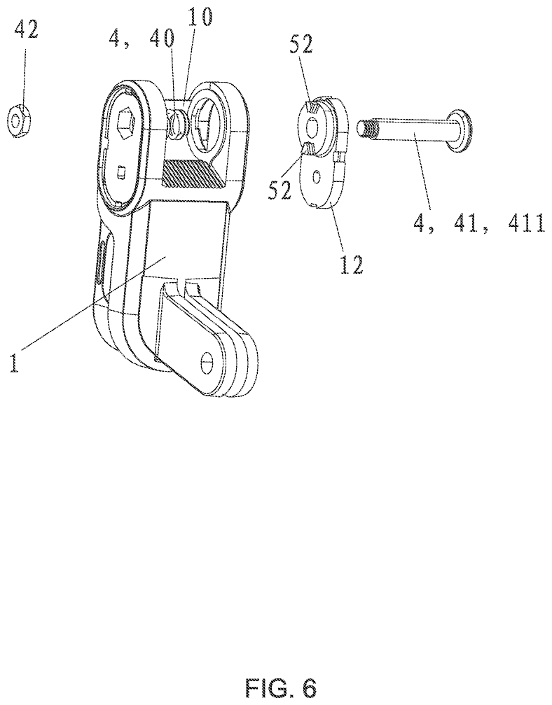

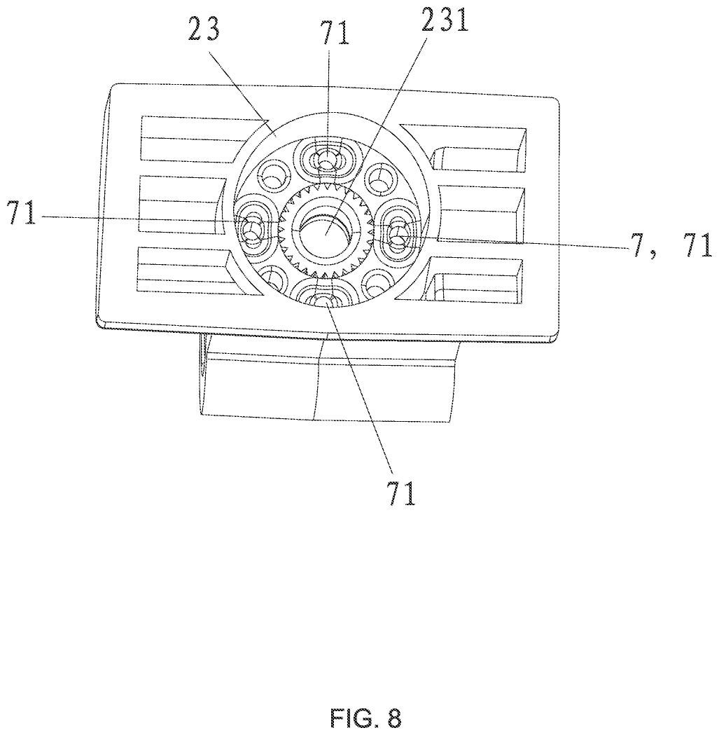

As shown in FIGS. 8 and 6, the second joint member 2 is concavely provided with a circular groove 23 for one end of the third joint member 3 to extend thereto, the third joint member 3 is provided with a circular segment 31 for extending into the circular groove 23. The circular groove 23 is provided with a screw hole 231, the second bolt 61 passes longitudinally through the circular segment 31 and is threaded to the screw hole 231.

As mentioned above, the circular groove 23 of the second joint component 2 in the present disclosure is arranged to facilitate an extension of the circular segment 31 of the third joint member 3 thereto, playing a limit and positioning role. In combination with the setting of the second bolt 61 longitudinally passing through the circular segment 31 and connecting with the screw hole 231 in the circular groove 23, the rotational connection between the second joint member 2 and the third joint member 3 can be more stable and not easily inclined.

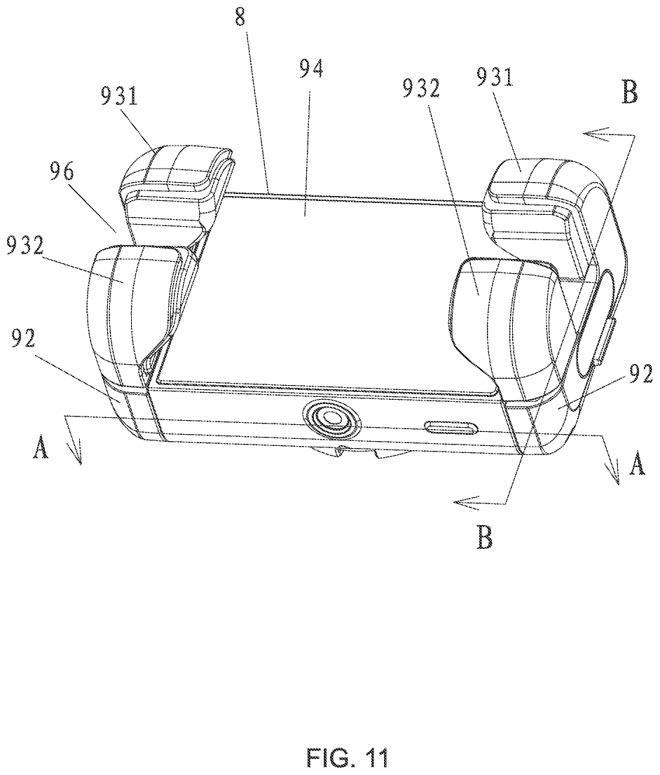

As shown in FIGS. 11 to 15, the clamping component 9 includes a movable seat 92 connected to a left side of the rotating seat 8 through a first self-resetting guide mechanism 91 and a movable seat 92 connected to a right side of the rotating seat 8. Each movable seat 92 can move away/close to the rotating seat 8 along the left and right axis and reset in a direction close to the rotating seat 8 under the drive of the first self-resetting guide mechanism 91. Each movable seat 92 is provided with a first clamping body 931 and a second clamping body 932 distributed in front and back. A first clamping space 94 is formed between the clamping body on the left side of the movable seat 92 and the clamping body on the right side of the movable seat 92 for gripping a mobile phone. The first clamping body 931 is fixed on the movable seat 92, and the second clamping body 932 is hinged on the movable seat 92 to swing around the left and right axis and move away/close to the first clamping body 931. A second self-resetting mechanism 95 is provided between the second clamping body 932 and the movable seat 92 to drive the second clamping body 932 to swing and reset in a direction of the first clamping body 931. A second clamping space 96 is formed between the first clamping body 931 and the second clamping body 932 for gripping the mobile phone.

As mentioned above, the first clamping space 94 and the second clamping space 96 are formed between the clamping bodies of the clamping components 9 in the preset disclosure, which facilitates selecting a corresponding clamping space according to a need and clamping the mobile phone, has good practicality.

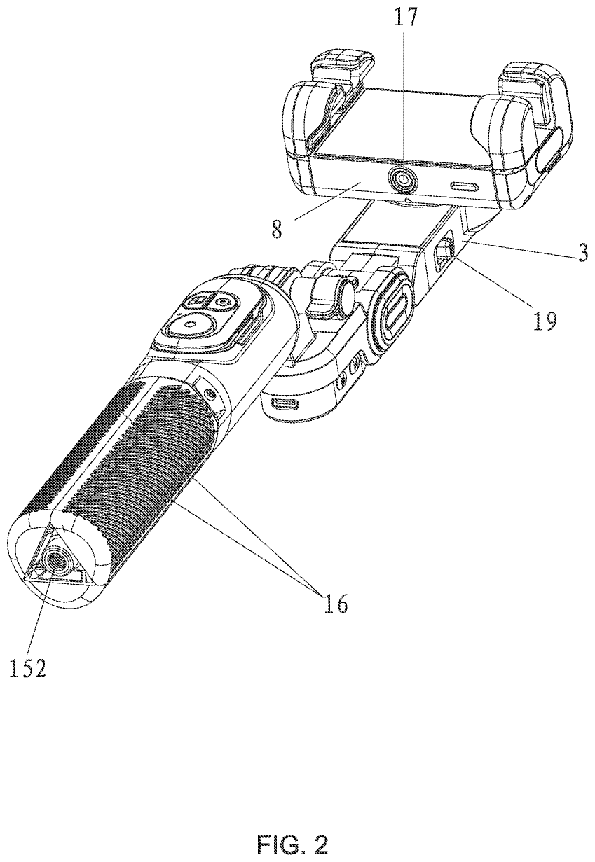

As shown in FIG. 11, the first self-resetting guide mechanism 91 includes several guide grooves 911 that extend left and right on the rotating seat 8. The guide groove 911 is provided with a guide rod 912 fixedly connected to the movable seat 92 at a corresponding side. A part of the guide rod 912 that is within the guide groove 911 is sleeved with a reset spring 913, as shown in FIG. 2, and/or the second self-resetting mechanism 95 includes a torsion spring 951 sleeved on a rotating shaft of the second clamping body 932. One end of the torsion spring 951 is fixed on the second clamping body 932, the other end thereof abuts against the movable seat 92 on a corresponding side.

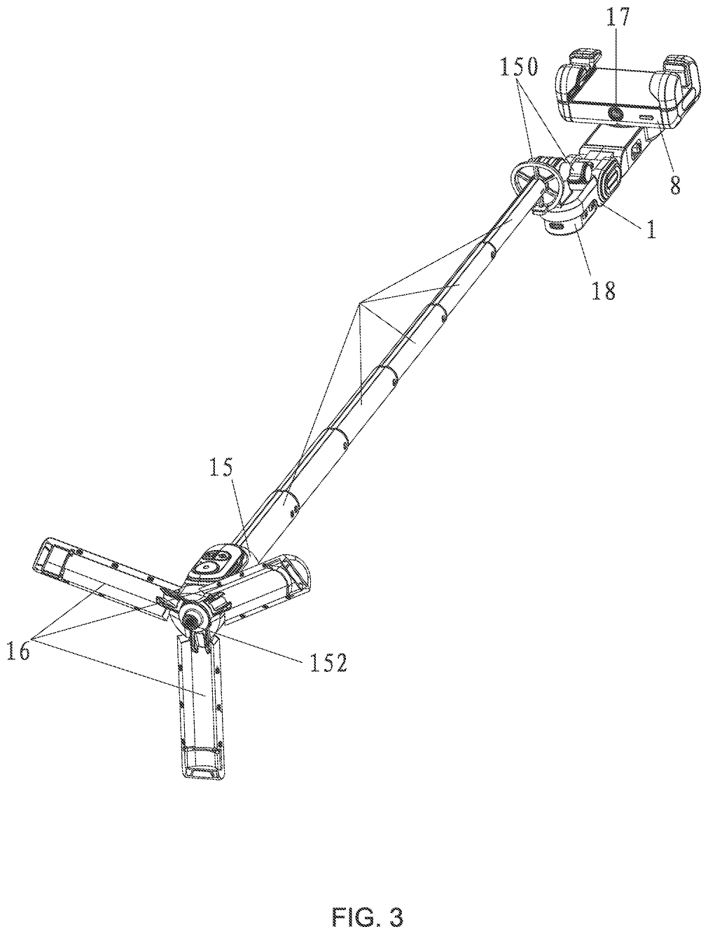

As shown in FIG. 3, the handle 15 is provided with a telescopic rod 151, a top of the telescopic rod 151 extended out is connected to the first joint 1 through the knob and nut assembly 150.

As shown in FIGS. 2 and 3, a camera 17 for capturing and tracking an object is provided on a side wall surface of the rotating seat 8.

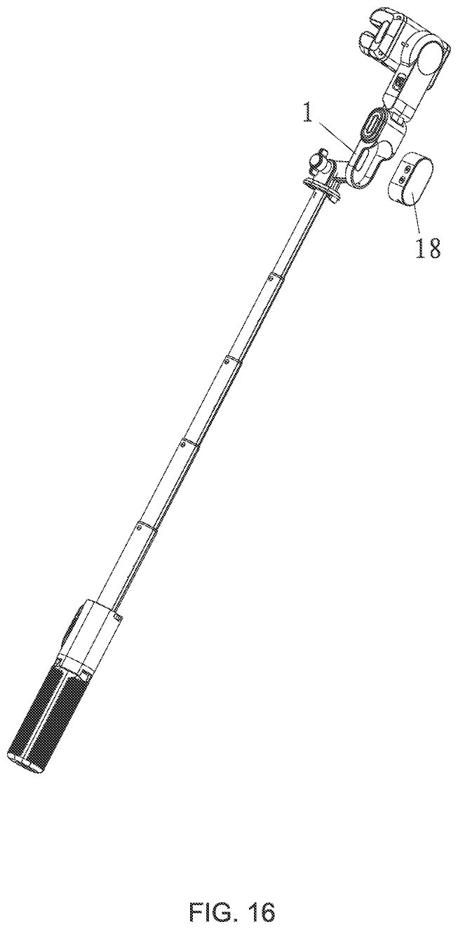

As shown in FIG. 16, a detachable magnetic fill light 18 is further provided on the first joint member 1.

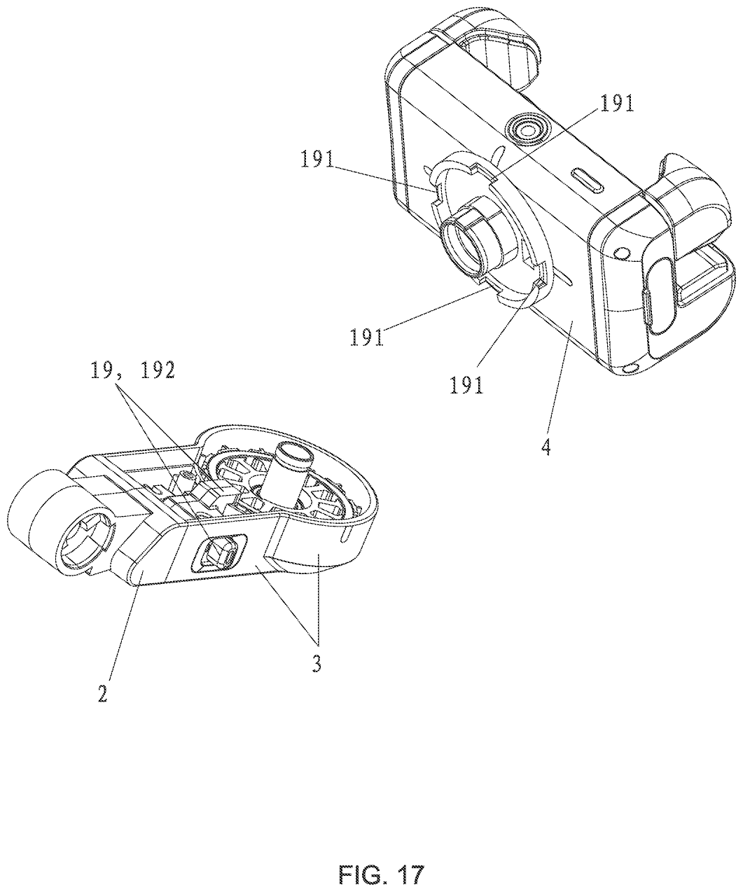

As shown in FIGS. 2 and 17, the third joint member 3 is provided with an adjustment component 19 for fixing/unlocking the rotating seat 8.

As shown in FIG. 17, during a specific implementation, the adjustment component 19 includes several pin grooves 191 distributed along the rotation axis on the rotating seat 8. The third joint member 3 is provided with an adjustment pin 192, which can approach/move away from the rotation axis of the rotating seat 8 to insert/exit the pin grooves 191 at a corresponding position.

As shown in FIGS. 2 and 3, during a specific implementation, a bottom of the handle 15 is further provided with an expansion interface 152 for an external expansion device to connect and fix on the mobile phone pan tilt. The expansion interface 152 is a nut or a regular polygon countersunk hole, which facilitates a connection of some auxiliary devices at the bottom of the handle 15 through the expansion interface 152.

As mentioned above, the present disclosure seeks to protect a handheld floor pan tilt, and all technical solutions that are the same or similar to the present disclosure are falling within the protection scope of the present disclosure.

What is claimed is:

1. A handheld floor pan tilt, comprising a first joint member (1), a second joint member (2), a third joint member (3), and a handle (15),
wherein the handle (15) is connected with the first joint member (1) that can rotate and adjust front and rear positions and be fixed through a knob and a nut assembly (150);
the first joint member (1) is connected with the second joint member (2) that can rotate and adjust a position around a lateral axis body (411) and limit a lateral movement through a first connection mechanism (4);
the first connection mechanism (4) comprises a first elastic member (40) for elastically driving the second joint member (2) to reset the lateral movement;
a first multi gear lateral clamp positioning mechanism (5) is provided between the first joint member (1) and the second joint member (2) that prevents a relative rotation between the first joint member (1) and the second joint member (2) after a horizontal movement and resetting of the second joint member (2) is in place;
the second joint member (2) is connected with the third joint member (3) that can rotate and adjust a position around a longitudinal axis body (611) and limit a longitudinal movement through a second connection mechanism (6),
the second connection mechanism (6) comprises a second elastic member (60) for elastically driving the third joint member (3) to longitudinally move and reset;
a second multi gear longitudinal clamp positioning mechanism (7) is provided between the second joint member (2) and the third joint member (3) that prevents a relative rotation of the second joint member (2) and the third joint member (3) after a longitudinal movement and resetting of the third joint member (3) is in place;
the third joint member (3) is connected with a rotating seat (8) driven by an electric motor, the rotating seat (8) is provided with a clamping component (9) for clamping and fixing an external equipment, a side wall surface of the handle (15) is hinged with several circumferentially distributed foot supports (16) that can be opened and closed to support a selfie pan tilt to stand.

2. The handheld floor pan tilt according to claim 1, wherein the first joint member (1) is provided with a first clamp port (10) for one end of the second joint member (2) to extend therein; the first connection mechanism (4) comprises a first bolt (41) that horizontally passes through the first joint member (1) and the second joint member (2) at the first clamp port (10); the lateral axis body (411) is a part of the first bolt (41), and the other end of the first bolt (41) is connected with a first nut (42);
the first elastic member (40) is a spring sleeved on the first bolt (41) for elastically driving the second joint member (2) to move horizontally and reset, and/or the second connection mechanism (6) comprises a second bolt (61), configured to be thread connection with second joint member (2) or thread connection with a fix nut in the second joint member (2) after longitudinally passing through the third joint member (3);
wherein the longitudinal axis body (611) is a part of the second bolt (61), the second elastic member (60) is a spring sleeved on the second bolt (61) for elastically driving the third joint member (3) to longitudinal move and reset.

3. The handheld floor pan tilt according to claim 1, wherein the first multi gear lateral clamp positioning mechanism (5) comprises several first positioning grooves (51) that are distributed in a circular/arc shape on one side of the second joint member (2) and a first positioning protrusion (52) arranged on the first joint member (1) for lateral clamping with the first positioning groove (51); and/or the second multi gear longitudinal clamp positioning mechanism (7) comprises several second positioning grooves (71) that are distributed in a circular/arc shape on the second joint member (2), and a second positioning protrusion (72) that is longitudinally clamped with the second positioning groove (71) on the third joint member (3).

4. The handheld floor pan tilt according to claim 3, wherein one side of the first joint member (1) is provided with a first clamp hole (11), the first clamp hole (11) is detachably clamped and fixed with a first clamp block (12); one end of the first clamp block (12) penetrating into the first clamp hole (11) is provided with the first positioning protrusion (52), the first clamp block (12) is provided with a lateral channel for the lateral axis body (411) to cross, and/or one side of the second joint member (2) is provided with a second clamp hole (21), the second clamp hole (21) is detachably clamped with a second clamp block (22), the first positioning groove (51) is provided on the second clamp block (22), the second clamp block (22) is provided with a lateral channel for the lateral axis body (411) to cross.

5. The handheld floor pan tilt according to claim 2, wherein the second joint member (2) is provided with a circular groove (23) for one end of the third joint member (3) to extend therein; the third joint member (3) is provided with a circular segment (31) for extending into the circular groove (23), the circular groove (23) is provided with a screw hole (231), the second bolt (61) longitudinally passes through the circular segment (31) and is thread connection to the screw hole (231).

6. The handheld floor pan tilt according to claim 1, wherein the clamping component (9) comprises a movable seat (92) connected to a left side of the rotating seat (8) through a first self-resetting guide mechanism (91) and a movable seat (92) connected to a right side of the rotating seat (8), each movable seat (92) can move away/close to the rotating seat (8) along the left and right axis and reset in a direction close to the rotating seat (8) under a driving force of the first self-resetting guide mechanism (91); each movable seat (92) is provided with a first clamping body (931) and a second clamping body (932) distributed front and rear, a first clamping space (94) is formed between the clamping body of the movable seat (92) on the left side and the clamping body of the movable seat (92) on the right side for gripping a mobile phone; the first clamping body (931) is fixed on the movable seat (92), the second clamping body (932) is hinged on the movable seat (92) to swing around the left and right axis and move away/close to the first clamping body (931);
a second self-resetting mechanism (95) is provided between the second clamping body (932) and the movable seat (92) for driving the second clamping body (932) to swing and reset in a direction of the first clamping body (931);
a second clamping space (96) is formed between the first clamping body (931) and the second clamping body (932) for gripping the mobile phone.

7. The handheld floor pan tilt according to claim 6, wherein the first self-resetting guide mechanism (91) comprises several guide grooves (911) extending left and right on the rotating seat (8), wherein the guide grooves (911) are provided with a guide rod (912) fixedly connected to the movable seat (92) on a corresponding side; a portion of the guide rod (912) located within the guide groove (911) is sleeved with a reset spring (913); and/or the second self-resetting mechanism (95) comprises a torsion spring (951) sleeved on a rotating shaft of the second clamping body (932), one end of the torsion spring (951) is fixed on the second clamping body (932) and the other end thereof abuts against the movable seat (92) on a corresponding side.

8. The handheld floor pan tilt according to claim 1, wherein the handle (15) is provided with a telescopic rod (151), a top of the telescopic rod (151) that extends out is connected to the first joint member (1) through the knob and the nut assembly (150).

9. The handheld floor pan tilt according to claim 1, wherein a camera (17) is provided on a side wall surface of the rotating seat (8) for capturing and tracking an object.

10. The handheld floor pan tilt according to claim 1, wherein a detachable magnetic fill light (18) is further provided on the first joint member (1).

11. The handheld floor pan tilt according to claim 1, wherein an adjustment component (19) is provided on the third joint member (3) for fixing/unlocking the rotating seat (8).

12. The handheld floor pan tilt according to claim 11, wherein the adjustment component (19) comprises several pin grooves (191) circumferentially distributed along a rotation axis on the rotating seat (8); an adjustment pin (192) is provided on the third joint member (3); the adjustment pin (192) can approach/move away from the rotation axis of the rotating seat (8) to insert/exit and rotate to the pin groove (191) at a corresponding position.

13. The handheld floor pan tilt according to claim 1, wherein a bottom of the handle (15) is further provided with an expansion interface (152) for an external expansion device to connect and fix on a mobile phone pan tilt, and the expansion interface (152) is a nut or a regular polygon countersunk hole.
